(19) United States
(12) Patent Application Publication
(10) Pub. No.: US 2014/0214261 A1
(43) Pub. Date: Jul. 31, 2014

(54) Remotely monitoring vehicle information using Wi-Fi Direct

(71) Applicant: HCL Technologies Limited, Chennai (IN)

(72) Inventors: Kumaralingam Ramamoorthy, Chennai (IN); Vengadassalabady Ramanouudjam, Chennai (IN); Rahul Ganapathy Subramaniam, Chennai (IN); Joy Esther Samuel, Chennai (IN)

(73) Assignee: HCL Technologies Limited, Chennai (IN)

(21) Appl. No.: 13/901,493

(22) Filed: May 23, 2013

(30) Foreign Application Priority Data
Jan. 29, 2013 (IN) 384/CHE/2013

(51) Int. Cl. G07C 5/00

(52) U.S. Cl. CPC G07C 5/008
USPC 701/31.5

(57) ABSTRACT

The embodiment provides a method for remotely monitoring a vehicle using a Wi-Fi Direct (WFD) network. The method includes establishing a WFD based connection with an electronic device in the WFD network and receiving information associated with the vehicle using the WFD based connection. Further, the method includes analyzing the received information based on a plurality of rules and displaying the analyzed information in the WFD network.

### PRIORITY DETAILS

The present application claims priority from Indian Application Number 384/CHE/2013, filed on 29 Jan. 2013, the disclosure of which is hereby incorporated by reference herein.

### TECHNICAL FIELD

The embodiments herein relate to Wi-Fi Direct networks, and more particularly, to a mechanism for monitoring vehicle information using Wi-Fi Direct and smart devices.

### BACKGROUND OF EMBODIMENT

A Wi-Fi Direct (WFD) network is a network system suggested by the Wi-Fi Alliance that enables Wi-Fi devices to be connected to each other in a peer-to-peer (P2P) fashion without participating in a home network, an office network, a hot-spot network, and the like. Conventional systems and methods includes monitoring a vehicle diagnostic information and use the information to perform analytics, such as to increase the vehicle performance, provide cost effective offers, and manage risk profiles of the vehicle users. The systems and methods uses remote transmitter including radio frequency communications channels with a set of buttons for each function to remotely mange the information, while constantly using the network infrastructure which may increase the overall cost of the system. Further, the vehicle information is usually extracted by using vector analyzers, which may be embodied in the vehicle interfaces, such as to tap specific signals on the communications channels.

Though the existing systems and methods are effective in monitoring and analyzing the vehicle information but include both advantages and disadvantages in terms of performance, range, security, ease of use, cost, user experience, ubiquity, optimization, and network infrastructure used.

### SUMMARY

Accordingly the embodiment provides a method for remotely monitoring a vehicle using a Wi-Fi Direct (WFD) network. The method includes establishing a WFD based connection with an electronic device in the WFD network and receiving information associated with the vehicle using the WFD based connection. Further, the method includes analyzing the information based on a plurality of rules and displaying the analyzed information in the WFD network.

Furthermore, the method includes configuring a WFD interface on the vehicle and identifying the vehicle using a WFD identifier associated with the vehicle in the WFD network. Furthermore, the method includes authenticating the vehicle in the WFD network and encoding/decoding the information associated with the vehicle in the WFD network. Furthermore, the method includes performing an action based on the analyzed information in the WFD network and displaying the analyzed information on the vehicle and/or the electronic device.

Accordingly the embodiment provides a system for monitoring a vehicle using a Wi-Fi Direct (WFD) network. The system includes an electronic device configured to establish a WFD based connection with the vehicle in the WFD network and receive information associated with the vehicle using the WFD based connection. Further, the electronic device is configured to analyze the information based on a plurality of rules and display the analyzed information in the WFD network.

Further, the system includes a WFD interface configured on the vehicle and/or the electronic device to establish the WFD based connection in the WFD network. Furthermore, the electronic device is configured to identify the vehicle using a WFD identifier associated with the vehicle authenticate the vehicle in the WFD network. Furthermore, the electronic device is configured to identify encode and decode the information associated with the vehicle in the WFD network. Furthermore, the electronic device is configured to perform an action based on the analyzed information in the WFD network and display the analyzed data on the vehicle and/or the electronic device.

These and other aspects of the embodiments herein will be better understood when considered in conjunction with the following description and the accompanying drawings. It should be understood, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments herein will be better understood from the following detailed description with reference to the drawings, in which:

FIG. 1 illustrates generally, among other things, a system accessing a WFD network, according to the embodiments disclosed herein;

FIG. 2 expands features and functions of the system as described in the FIG. 1, according to embodiments described herein;

FIG. 3 is a sequence diagram illustrating operations performed by the system as described in the FIG. 1, according to the embodiments disclosed herein;

FIG. 4 is a sequence diagram illustrating operations performed by the system using a cloud server as described in the FIG. 2, according to the embodiments disclosed herein;

FIG. 5 is a flowchart illustrating a method for monitoring vehicle information using the WFD network, according to the embodiments disclosed herein; and

FIG. 6 illustrates a computing environment implementing the method and system as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for monitoring a vehicle using a Wi-Fi Direct (WFD) network. The vehicle can be configured to include WFD interface(s), such as to establish a connection with one or more electronic devices in the WFD network. The WFD interface enables the vehicle to connect with other electronic devices in a peer-to-peer (P2P) fashion without participating in a home network, an office network, a hot-spot network, or using network infrastructure. Upon establishing the connection, the electronic device can be configured to receive the information associated with the vehicle. The electronic device identifies each vehicle using the WFD identifier associated with the vehicle. Further, the electronic device can be configured to execute a plurality of rules on the received information, such as to provide effective, efficient, and reliable decision/support and manage risk profiles of the vehicle users. Further, the electronic device can be configured to communicate with one or more cloud devices to perform the data analytics on the received information. Furthermore, the analyzed information can be displayed on the vehicle and electronic device displays.

The proposed system and method is simple, robust, dynamic, in expensive, and reliable for remotely monitoring and performing analytics on the vehicle information using the WFD. Unlike the convention systems, the use of WFD enabled devices and network can increases the speed, range, and performance with reasonable system cost and time. The proposed system can be used to establish a P2P connection between the devices, such as to reduce the risk of inference and provide highly secure communications throughout the system. Further, the system can be used to efficiently analyze the vehicle information and provide effective solutions and suggestions to user(s). The system can further be used to perform target marketing based on the analyzed information. Furthermore, the proposed system and method can be implemented on the existing infrastructure and may not require extensive set-up or instrumentation.

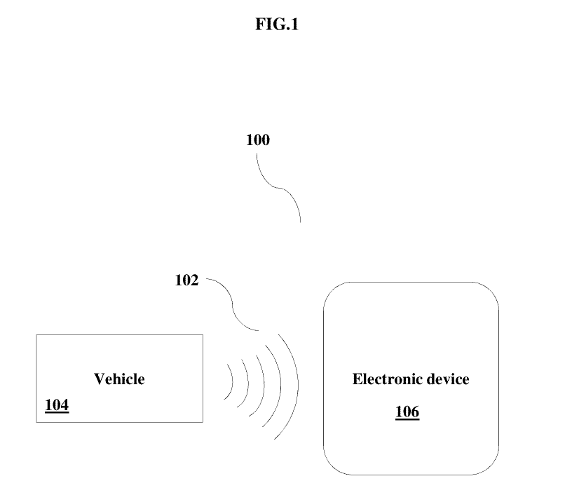

FIG. 1 illustrates generally, among other things, a system 100 accessing a Wi-Fi Direct (WFD) network 102, according to the embodiments disclosed herein. The system 100 can include one or more vehicles 104 (hereafter referred as vehicle 104) and one or more electronic devices 106 (hereafter referred as electronic device 106) communicating among each other using the WFD network 102.

In an embodiment, the vehicle 104 described herein can include for example, but not limited to, a car, bus, train, bike, truck, aircraft, or any other type of vehicle capable of including sufficient firmware to communicate with the electronic devices 106 over the WFD network 102. Further, the vehicle 104 can be configured to include or be coupled to WFD interface(s) units dynamically establish a connection with the electronic devices 106 and perform other functions in the WFD network 102.

In an embodiment, the electronic devices 106 described herein can include for example, but not limited to, smart phones, personal digital assistances (PDAs), communicators, wireless electronic devices, laptops, computers, desktops, cloud devices, servers, combination thereof, or any other electronic devices including sufficient firmware to communicate with the vehicle 104 over the WFD network 102. Further, the electronic device 106 can be configured to include WFD interface(s) such as to dynamically establish a connection with the vehicle 104 in the WFD network 102.

In an example, the system 100 can be configured to include Wi-Fi display certified devices, such as to display information among each other. The vehicle 104 and the electronic device 106, within the WFD network 102, can be directly connected to each other without using a wireless local area network (WLAN) access point (AP). For such a direct connection between the vehicle 104 and the electronic device 106, the system 100 can be configured to use a new firmware protocol (such as Wi-Fi Direct). The protocol can enables the vehicle 104 and the electronic devices 106 to connect with each other in a peer-to-peer (P2P) fashion without participating in a home network, an office network, a hot-spot network, WLAN AP, or using any other network infrastructure. The use of such WFD devices and network can increases the overall system performance, speed, and range thereby significantly reducing the system cost.

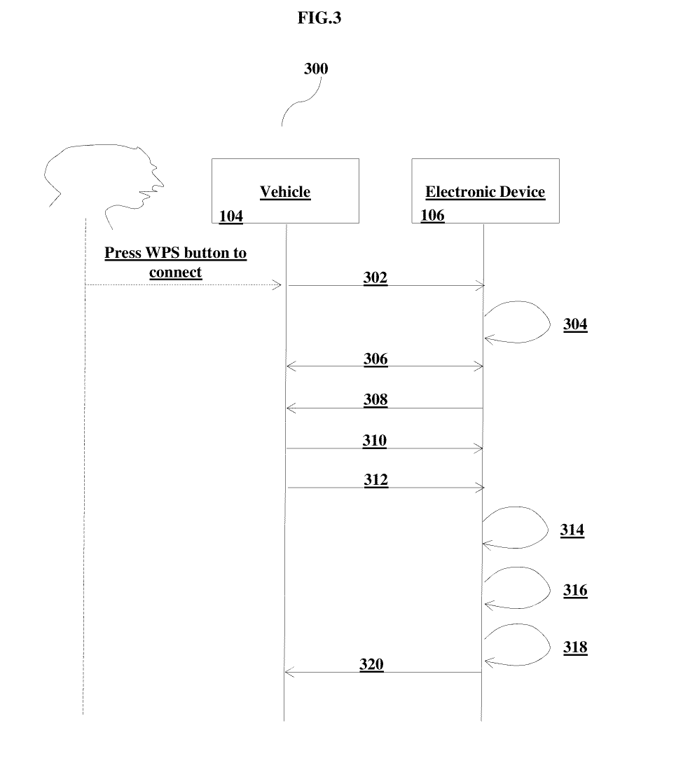

In the FIG. 1, the vehicle 104 can be any type of vehicle including WFD interfaces configured thereon, whereas the electronic device 106 is a smart device, though it is understood that another exemplary embodiment is not limited thereto. The vehicle 104 and electronic device 106 can establish a direct P2P connection between each other using the WFD network 102. Further, the direct P2P connection can reduces the risk of inference and provide highly secure communications throughout the system 100. Further, the operations performed between the vehicle 104 and the electronic device 106, are described in conjunction with the FIG. 3.

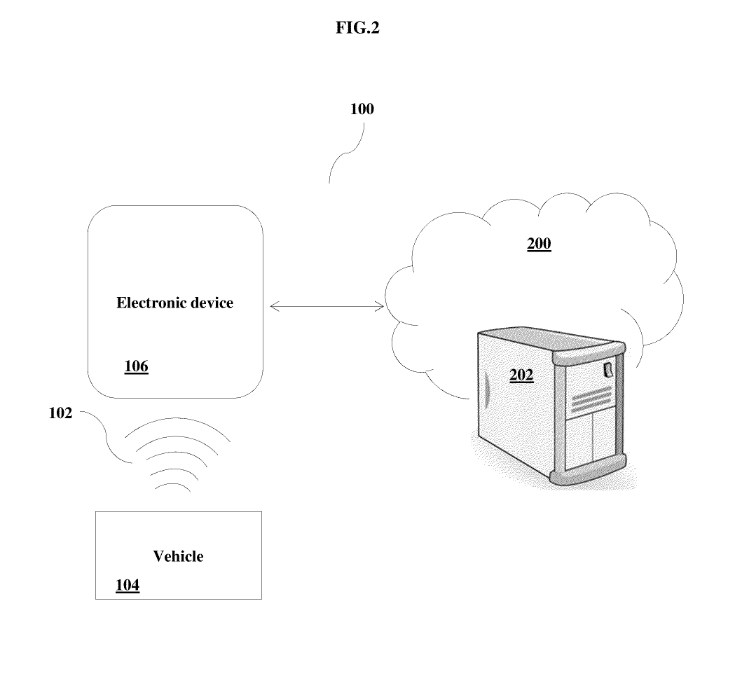

FIG. 2 expands features and functions of the system 100 as described in the FIG. 1, according to embodiments described herein. In an embodiment, the vehicle 104 can be configured to dynamically connect with the electronic device 106 over the WFD network 102. The vehicle 104 can be configured to include WFD interface unit to dynamically create a secure and unique communication channel with the electronic device 106. In an example, the WFD interface unit can be configured interface with various interfaces such as Flex-Ray, Digital and Analog input/output, controller area network (CAN), local interconnect network (LIN), serial ports, and the like, such as to establish a WFD based connection with the electronic device 106 over the WFD network 102.

In an embodiment, upon establishing the WFD based connection, the electronic device 106 can be configured to receive information associated with the vehicle 104. In an embodiment, the information associated with the vehicle 104 can include for example, but not limited to, fuel level, fuel tank pressure voltage, engine load, engine Revolutions/Rotation per minute (RPM), vehicle speed, battery voltage, engine coolant temperature, total number of miles travelled by the vehicle, insurance details, pollution details, and the like. In an embodiment, the information can be encoded/encrypted before sending to the electronic device 106. The system 100 can be configured to use an Advanced Encryption Standard (AES) 256-bit encryption technique to encrypt the information and provide security to the information associated with the vehicle 104.

Further, the electronic device 106 can be configured to decode and execute a plurality of rules to analyze the received information, such as to provide effective and efficient solutions/support to the vehicle user. The detailed operations performed between the vehicle 104 and the electronic device 106, are described in conjunction with the FIG. 3.

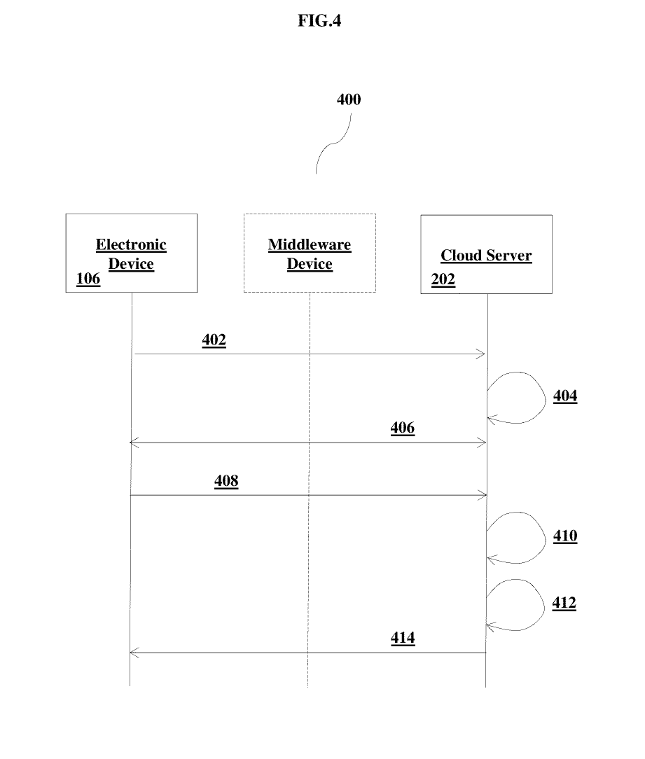

In an embodiment, the electronic device 106 can be configured to communicate with a cloud platform 200 for analyzing the information received from the vehicle 104. The cloud platform 200 include a cloud server 202 configured to execute a plurality of rules on the received information and provide effective solutions/support to the vehicle user. The detailed operations performed between the electronic device 106 and the cloud server 202, are described in conjunction with the FIG. 4.

In an embodiment, the electronic device 106 can be configured to connect with the cloud devices (for e.g., the server 202) using a communication network. The communication network described herein can include for example, wireless communication network, wire-line communication network, global system for mobile communication (GSM) network, cellular communication network, local area network (LAN), wide area network (WAN), combination thereof, or any other network.

FIG. 3 is a sequence diagram illustrating operations 300 performed by the system 100 as described in the FIG. 1, according to the embodiments disclosed herein. The operations 300 are performed between the vehicle 104 and the electronic device 106. In an embodiment, at 302, the vehicle 104 can dynamically send a request to establish a connection with the electronic device 106 over the WFD network 102. In an example, the vehicle 104 can be configured to use the WFD interface to dynamically provide the request for establishing a WFD based connection with the electronic device 106. In an example, the driver or any other user of the vehicle can also manually send the request by pressing a WPS-based button present on the vehicle 104.

In an embodiment, at 304, upon receiving the request from the vehicle 104, the electronic device 106 can enable a group owner to create a P2P connection. In an example, the electronic device 106 can be configured to communicate with Dynamic Host Configuration Protocol (DHCP) server of the group owner to establish a WFD based P2P connection with the vehicle 104. Further, the electronic device 106 can be configured to setup multiple P2P links with the vehicles 104 to monitor multiple vehicle information at substantially the same time.

In an embodiment, at 306, the electronic device 106 can authenticate the vehicle 104 and create the WFD based P2P connection with the vehicle 104. In an example, the electronic device 106 can be configured to perform a 4-way handshake between the vehicle 104 and the electronic device 106. The group owner can perform a peer (the vehicle 104) discovery to initiate a communication and perform the 4-way handshake between the vehicle 104 and the electronic device 106. Further, in response to successful authentication, the electronic device 106 can be configured to create a WFD based P2P connection with the vehicle 104, without using a home network, an office network, a hot-spot network, WLAN AP, or any other network infrastructure. Furthermore, a secure communication channel can be provided by using the WFD based P2P connection thereby significantly reducing the risk of interference with other network device and radio frequencies.

In an embodiment, at 308, the electronic device 106 can request a WFD identifier associated with the vehicle 104. In an example, the WFD identifier can be used by the electronic device 106 to uniquely identify the vehicle 104 in the WFD network 102, thereby eliminating the risk of cross connection with other vehicles present in the WFD network 102. The WFD identifier described herein can include for example, a WFD Media Access Control (MAC) address associated with the vehicle 104.

In an embodiment, at 310, upon receiving the request, the vehicle 104 can send the associated WFD identifier to the electronic device 106. In an example, where the vehicle is not WFD enabled, the electronic device 106 can use the normal Wi-Fi MAC address associated with the vehicle to uniquely identify the vehicle 104 in the WFD network 102.

In an embodiment, at 312, the electronic device 106 can receive the information associated with the vehicle 104. In an example, the electronic device 106 can be configured to send a request to the vehicle 104, such as to receive the information associated with the vehicle 104. In an example, a user of the electronic device 106 can customize the request by selecting required information of the vehicle 104. The information associated with the vehicle 104 can include for example, but not limited to, fuel level, fuel tank pressure voltage, engine load, engine RPM, vehicle speed, battery voltage, engine coolant temperature, total number of miles travelled by the vehicle, insurance details, pollution details, or any other information. In an example, the information can be encoded/encrypted before sending to the electronic device 106. The vehicle 104 can be configured to use the AES 256-bit encryption technique to encode/encrypt the information, such as to provide security to the information associated with the vehicle 104.

In an example, at 314, the electronic device 106 can execute or apply a plurality of rules on the received information to provide solutions and support to the vehicle user. In an example, the electronic device 106 can be configured to include the plurality of rules to analyze the received information and provide associated solutions, recommendations, and suggestions to the vehicle users. In an example, the received information can be decoded/decrypted and analyzed based on the applicable rules, such as to increase the vehicle performance, provide cost effective offers, and manage risk profiles of the vehicle users. In an example, the electronic device 106 can be configured to communicate with other components and devices present in the cloud to analyze the received information. The operations performed by the electronic device and cloud components are described in conjunction with the FIG. 4.

In an embodiment, at 316, the electronic device 106 can dynamically perform one or more actions based on the analyzed information. For example, if the insurance information associated with the vehicle 104 is about to expire then the electronic device 106 can be configured to apply the rules and suggests the vehicle user to renew the insurance. Further, the electronic device 106 can be configured to automatically communicate with the insurance providers to renew the insurance associated with the vehicle 104. In an embodiment, the electronic device 106 can be configured to communicate with different device in the WFD network 102, such as to enhance the user experience and provide cost effective, efficient, robust, and reliable solutions/support to the user.

In an embodiment, at 318, the electronic device 106 enables the user to view the solutions and actions performed by the electronic device 106. In an example, the electronic device 106 can be configured to display the analyzed information, which can enable the user to actively take the decisions.

In an embodiment, at 320, the electronic device 106 can display the solution, support, and actions performed by the electronic device 106 on the vehicle display. In an example, the vehicle 104 can be configured to include a user interface such as to provide a visual presentation of the information, associated solutions/support, and actions performed by the electronic device 106.

FIG. 4 is a sequence diagram illustrating operations 400 performed by the system 100 using the cloud server 202 as described in the FIG. 2, according to the embodiments disclosed herein. The operations 400 are performed between the electronic device 106 and the cloud server 202. In an embodiment, the vehicle 104 can be configured to create a WFD based P2P connection with the electronic device 106 as described in the FIG. 3. The electronic device 106 can use the WFD MAC identifier to uniquely identify the vehicle 104 in the WFD network. After establishing the connection, the electronic device 106 can receive the information associated with the vehicle 104. The information received by the electronic device 106 can include for example, but not limited to, fuel level, fuel tank pressure voltage, engine load, engine RPM, vehicle speed, battery voltage, engine coolant temperature, total number of miles travelled by the vehicle, insurance details, pollution details, or any other information associated with the vehicle 104. Further, the electronic device 106 can be configured to communicate with the one or more cloud devices/components (for example, the server 202) to analyze the information received from the vehicle 104.

In an embodiment, at 402, the electronic device 106 can send a request including the WPS MAC identifier to get connected with the cloud server 202. In an example, the cloud platform can include various middleware devices such as routers, gateways, hubs, switches, communicators, traffic concentrators, and the like to communicate the request. The electronic device 106 can be configured to pass the WPS MAC identifier associated with the vehicle 104 to create a connection with the cloud server 202. Further, electronic device 106 can use the middleware device to route and communicate the request to the cloud server 202 over the communication network. In an example, the communication network described herein can include for example, wireless communication network, wire-line communication network, global system for mobile communication (GSM) network, cellular communication network, local area network (LAN), wide area network (WAN), combination thereof, or any other communication network.

In an embodiment, at 404, the server 202 can validate the request received from the electronic device 106. In an example, the server 202 can be configured to validate the WFD MAC identifier associated with the vehicle 104 to establish a secure communication with the electronic device 106. In an embodiment, at 406, the server 202 can establish a secure connection with the electronic device 106. In an example, upon successful validation, the server 202 can send a positive acknowledgement to the middleware device for dynamically establishing a session with the electronic device 106.

In an embodiment, at 408, the electronic device 106 can transfer the received information to the server 202. In an example, the electronic device 106 can be configured to packetize the received information into custom frames and transfer the information to the server 202. In an example, transferring the information associated with the vehicle 104 over the cloud (or any third-party applications, cloud components, devices, and networks) can involve privacy concerns. Options are available to address the privacy concerns. The options may include that an administrator or security applications may be chosen to opt-in to participate or to opt-out to not participate in monitoring or sharing of the information associated with the vehicle 104. Further, the electronic device 106 can be configured to encode or encrypt the received information before transferring to the server 102. In an example, the electronic device 106 can uses the AES 256-bit encryption technique to encrypt the received information before transferring to the server 102.

In an embodiment, at 410, the server 202 can execute a plurality of rules on the received information to provide solutions and support to the vehicle user. In an example, the server 202 can be configured to include the plurality of rules to analyze the received information and provide associated solutions, recommendations, and suggestions to the vehicle users. In an example, the received information can be decoded/decrypted and analyzed based on the applicable rules, such as to increase the vehicle performance, provide cost effective offers, and manage risk profiles of the vehicle users.

In an embodiment, at 412, the server 202 can dynamically perform one or more actions based on the analyzed information. For example, if the number of miles travelled by the vehicle 104 reaches a threshold then the server 202 can execute the applicable rules and suggest the vehicle user for the vehicle service. Further, the server 202 can be configured to automatically book a schedule with the service provider for the vehicle service. In an embodiment, the server 202 can be configured to communicate with different device in the WFD network 102, such as to enhance the user experience and provide cost effective, efficient, robust, and reliable solutions/support to the user.

In an embodiment, at 414, the server 202 enables the user to view the solutions and actions performed by the server 202. In an example, the server 202 can be configured to display the analyzed information, which supports the user of the electronic device 106 to actively make decisions. Alternatively, the electronic device 106 can display the solution, support, and actions performed by the server 202 on the vehicle display.

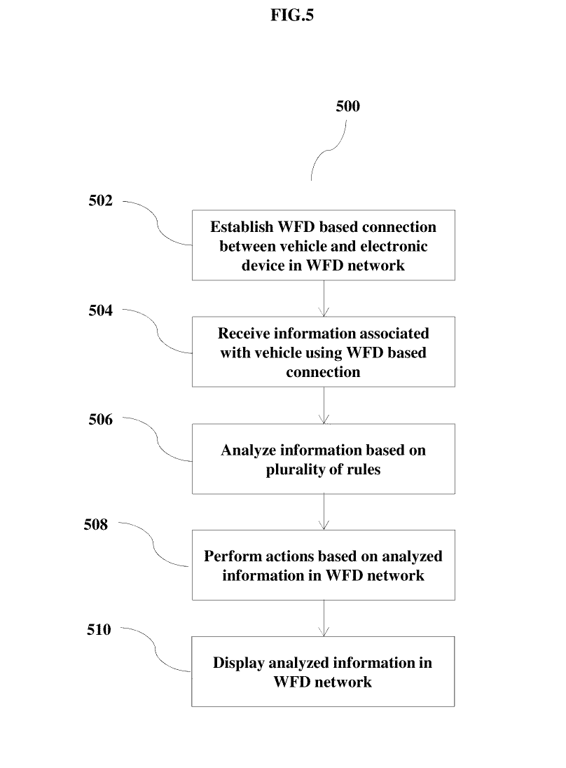

FIG. 5 is a flowchart illustrating a method 500 for monitoring vehicle information using the WFD network 102, according to the embodiments disclosed herein. In an embodiment, the method 500 includes establishing a WFD based connection between the vehicle 104 and the electronic device 106 using the WFD network 106. In an example, the method 500 allows the electronic device 106 to receive a request via the WFD interface to dynamically establish the WFD based connection with the vehicle 104. Upon receiving the request, the electronic device 106 enables a group owner to create a P2P connection. Further, the method 500 allows the electronic device 106 to authenticate the vehicle 104 for establishing the connection with the vehicle 104. The group owner can discover a peer (the vehicle 104) and perform 4-way handshake between the vehicle 104 and the electronic device 106. Further, in response to successful authentication, the electronic device 106 creates the WFD based P2P connection with the vehicle 104, without using a home network, an office network, a hot-spot network, WLAN AP, or any other network infrastructure. Furthermore, a secure communication channel can be provided by using the WFD based P2P connection thereby significantly reducing the risk of interference with other network device and radio frequencies. Similarly, the electronic device 106 can setup multiple P2P links with the vehicles 104 to monitor multiple vehicle information at substantially the same time. The electronic device 106 can identify each vehicle based on the WFD identifier associated with the vehicle and eliminate the risk of cross connection with other vehicles present in the WFD network 102.

In an embodiment, at 504, the method 500 includes receiving information associated with the vehicle 104 using the WFD based connection. In an example, the method 500 allows the electronic device 106 to send a request to the vehicle 104 for receiving the information associated with the vehicle 104. The information associated with the vehicle 104 can include for example, but not limited to, fuel level, fuel tank pressure voltage, engine load, engine RPM, vehicle speed, battery voltage, engine coolant temperature, total number of miles travelled by the vehicle, insurance details, pollution details, or any other information. In an example, the information can be encoded/encrypted before sending to the electronic device 106. The AES 256-bit encryption technique can be used to encode/encrypt the information to provide security to the information associated with the vehicle 104.

In an embodiment, at 506, the method 500 includes analyzing the received information based on a plurality of rules. In an example, the method 500 allows the electronic device 106 to decode/decrypt the received information and execute the plurality of applicable rules to provide relevant solutions, recommendations, and suggestions to the vehicle users. The solutions offered to the vehicle user can be used to increase the vehicle performance, provide cost effective offers, and manage risk profiles of the vehicle users. In an example, the electronic device 106 can communicate with other components and devices present in the cloud to analyze the received information as described in the FIG. 4.

In an embodiment, at 508, the method 500 includes performing an action based on the analyzed information in the WFD network 102. In an example, the method 500 allows the electronic device 106 to dynamically perform one or more actions based on the analyzed information, such as to enhance the user experience and provide cost effective, efficient, robust, and reliable solutions/support to the user.

In an embodiment, at 510, the method 500 includes displaying the analyzed information in the WFD network 102. In an example, the method 500 allows the electronic device 106 to enable the user to view the solutions and actions performed, which can be further used by the user to actively take decisions.

The various actions, steps, blocks, or acts described with respect to the FIGS. 3 through 5 can be performed in sequential order, in random order, simultaneously, parallel, or a combination thereof. Further, in some embodiments, some of the steps can be omitted, skipped, or added without departing from the scope of the embodiment.

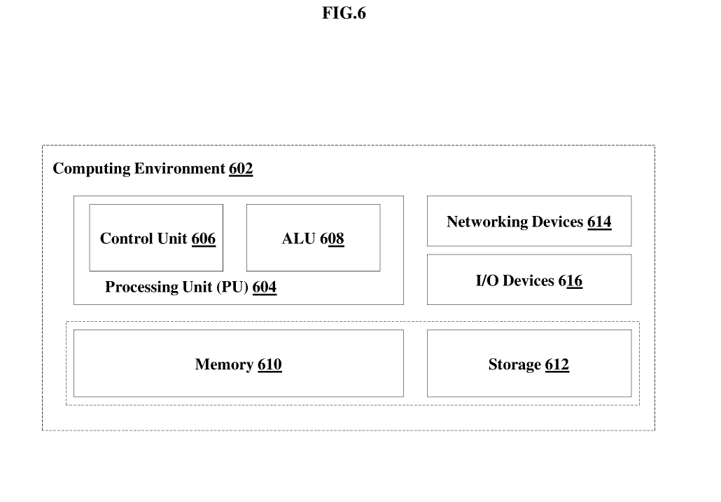

FIG. 6 illustrates a computing environment 602 implementing the method and systems as disclosed in the embodiments herein. As depicted the computing environment 602 comprises at least one processing unit 604 that is equipped with a control unit 606 and an Arithmetic Logic Unit (ALU) 608, a memory 610, a storage unit 612, plurality of networking devices 614 and a plurality Input output (I/O) devices 616. The processing unit 604 is responsible for processing the instructions of the algorithm. The processing unit 604 receives commands from the control unit 606 in order to perform its processing. Further, any logical and arithmetic operations involved in the execution of the instructions are computed with the help of the ALU 608.

The overall computing environment 602 can be composed of multiple homogeneous and/or heterogeneous cores, multiple CPUs of different kinds, special media and other accelerators. The processing unit 604 is responsible for processing the instructions of the algorithm. Further, the plurality of processing units 604 may be located on a single chip or over multiple chips.

The algorithm comprising of instructions and codes required for the implementation are stored in either the memory unit 610 or the storage 612 or both. At the time of execution, the instructions may be fetched from the corresponding memory 610 and/or storage 612, and executed by the processing unit 604.

In case of any hardware implementations various networking devices 614 or external I/O devices 616 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 6 include blocks, steps, operations, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for remotely monitoring a vehicle using a Wi-Fi Direct (WFD) network, the method comprising:
establishing a WFD based connection with at least one electronic device in said WFD network;
receiving information associated with said vehicle using said WFD based connection;
analyzing said information based on a plurality of rules; and
displaying said analyzed information in said WFD network.

2. The method of claim 1, wherein said method further comprises configuring a WFD interface on at least one of said vehicle and said electronic device.

3. The method of claim 1, wherein said method further comprises identifying said vehicle using a WFD identifier associated with said vehicle in said WFD network.

4. The method of claim 1, wherein said method further comprises authenticating said vehicle in said WFD network.

5. The method of claim 1, wherein said method further comprises encoding said information associated with said vehicle in said WFD network.

6. The method of claim 1, wherein said method further comprises decoding said information associated with said vehicle in said WFD network.

7. The method of claim 1, wherein said method further comprises performing at least one action based on said analyzed information in said WFD network.

8. The method of claim 1, wherein said analyzed data is displayed on at least one of said vehicle and said. electronic device

9. A system for monitoring a vehicle using a Wi-Fi Direct (WFD) network, the system comprising at least one electronic device configured to:
establish a WFD based connection with said vehicle in said WFD network, receive information associated with said vehicle using said WFD based connection,
analyze said information based on a plurality of rules, and
display said analyzed information in said WFD network.

10. The system of claim 9, wherein said system further comprises a WFD interface configured on at least one of said vehicle and said electronic device.

11. The system of claim 9, wherein said electronic device is further configured to identify said vehicle using a WFD identifier associated with said vehicle in said WFD network.

12. The system of claim 9, wherein said electronic device is further configured to authenticate said vehicle in said WFD network.

13. The system of claim 9, wherein said electronic device is further configured to encode said information associated with said vehicle in said WFD network.

14. The system of claim 9, wherein said electronic device is further configured to decode said information associated with said vehicle in said WFD network.

15. The system of claim 9, wherein said electronic device is further configured to perform at least one action based on said analyzed information in said WFD network.

16. The system of claim 9, wherein said analyzed data is displayed on at least one of said vehicle and said electronic device.
